(19) United States
(12) Patent Application Publication
(10) Pub. No.: US 2023/0294418 A1
(43) Pub. Date: Sep. 21, 2023

(54) THREE-DIMENSIONAL OBJECT PRINTING APPARATUS AND THREE-DIMENSIONAL OBJECT PRINTING METHOD

(71) Applicant: SEIKO EPSON CORPORATION, Tokyo (JP)

(72) Inventor: Takeshi TSUCHIYA, Shiojiri-shi (JP)

(21) Appl. No.: 18/183,824

(22) Filed: Mar. 14, 2023

(30) Foreign Application Priority Data
Mar. 15, 2022 (JP) 2022-039994

(51) Int. Cl. B41J 3/407; B41J 29/393

(52) U.S. Cl. CPC B41J 3/4073; B41J 29/393

(57) ABSTRACT

A three-dimensional object printing apparatus executes printing of a first common image and a first substitute image on a first workpiece, which is three-dimensional, and also executes printing of a second common image and a second substitute image on a second workpiece, which is also three-dimensional. The first common image and second common image are the same image. The first substitute image and second substitute image are at least partially different from each other. The three-dimensional object printing apparatus executes a first print operation, in which the first common image is printed on the first workpiece, before executing a second print operation, in which the first substitute image is printed on the first workpiece.

The present application is based on, and claims priority from JP Application Serial Number 2022-039994, filed Mar. 15, 2022, the disclosure of which is hereby incorporated by reference herein in its entirety.

### BACKGROUND

### 1. Technical Field

The present disclosure relates to a three-dimensional object printing apparatus and a three-dimensional object printing method.

### 2. Related Art

A known three-dimensional object printing apparatus uses a robot to perform printing on surfaces of a three-dimensional workpiece by an ink jet method. For example, the apparatus described in JP-A-2017-18884, which has an articulated robot and a print head supported by the articulated robot, discharges ink from the print head toward a surface of a base material having a curved-surface shape.

In JP-A-2017-18884, a plurality of design patterns of the same shape are printed on a surface of the base material.

In printing on a three-dimensional workpiece, both an image common to all workpieces and a workpiece-specific image may be printed on each workpiece. Although, in JP-A-2017-18884, successive printing of the same pattern is described, there is no description about printing of both a common image and a workpiece-specific image. In view of this situation, it is desirable to efficiently print both a common image and a workpiece-specific image on each workpiece.

### SUMMARY

To solve the above problem, a three-dimensional object printing apparatus according to one aspect of the present disclosure executes printing of a first common image and a first substitute image on a first workpiece, which is three-dimensional, and also executes printing of a second common image and a second substitute image on a second workpiece, which is also three-dimensional. The first common image and second common image are the same image. The first substitute image and second substitute image are at least partially different from each other. The three-dimensional object printing apparatus executes a first print operation, in which the first common image is printed on the first workpiece, before executing a second print operation, in which the first substitute image is printed on the first workpiece.

A three-dimensional object printing apparatus according to another aspect of the present disclosure prints, on a three-dimensional workpiece, a single image created from one piece of image data and a combined image created from a plurality of pieces of image data. The three-dimensional object printing apparatus executes a first print operation, in which the single image is printed, before executing a second print operation, in which the combined image is printed.

A three-dimensional object printing method according to one aspect of the present disclosure executes printing of a first common image and a first substitute image on a first workpiece, which is three-dimensional, and also executes printing of a second common image and a second substitute image on a second workpiece, which is also three-dimensional. The first common image and second common image are the same image. The first substitute image and second substitute image are at least partially different from each other. A first print operation, in which the first common image is printed on the first workpiece, is executed before a second print operation, in which the first substitute image is printed on the first workpiece, is executed.

### BRIEF DESCRIPTION OF THE DRAWINGS

FIG. 1 is a perspective view schematically illustrating a three-dimensional object printing apparatus according to an embodiment.

FIG. 2 is a block diagram illustrating the electric structure of the three-dimensional object printing apparatus according to the embodiment.

FIG. 3 is a perspective view schematically illustrating the structure of a head unit.

FIG. 4 illustrates a computer used in the three-dimensional object printing apparatus according to the embodiment.

FIG. 5 illustrates a flow of operations of the three-dimensional object printing apparatus according to the embodiment.

FIG. 6 illustrates of a printing operation of the three-dimensional object printing apparatus according to the embodiment.

FIG. 7 illustrates an example of a display on which to set a single image and a combined image.

FIG. 8 illustrates an example a preview display for a combined image.

FIG. 9 illustrates a flow of data processing for a single image and a combined image.

### DESCRIPTION OF EXEMPLARY EMBODIMENTS

A preferred embodiment of the present disclosure will be described below with reference to the attached drawings. The dimensions and scales of individual sections and portions in the drawings differ from their actual dimensions and scales, as appropriate. Some sections and portions in the drawings are schematically illustrated for easy understanding. The scope of the present disclosure is not limited to forms exemplified below unless, in the description below, there is a particular description that limits the present disclosure.

In the description below, the X-axis, Y-axis, and Z-axis, which are mutually orthogonal, are appropriately used for convenience. In the description below, one direction along the X-axis is the X1 direction and a direction opposite to the X1 direction is the X2 direction. Similarly, mutually different directions along the Y-axis are the Y1 direction and Y2 direction; and mutually different directions along the Z-axis are the Z1 direction and Z2 direction.

The X-axis, Y-axis, and Z-axis are equivalent to the coordinate axes in a world coordinate system set in a space in which a robot 2, which will be described later, is set. Typically, the Z-axis is the vertical axis and the Z2 direction is equivalent to the downward direction of the vertical direction. The world coordinate system is associated with a base coordinate system, in which the position of a base 210, which will be described later, of the robot 2 is used as a reference, through calibration. In the description below, a case will be exemplified in which the world coordinate system is used as a robot coordinate system for convenience when operations of the robot 2 are controlled.

The Z-axis may not be vertical. Typically, the X-axis, Y-axis, and Z-axis are mutually orthogonal. However, this is not a limitation. In some cases, the X-axis, Y-axis, and Z-axis are not mutually orthogonal. For example, the X-axis, Y-axis, and Z-axis only need to cross one another at angles of 80° to 100°.

### 1. Embodiment

### 1-1. Outline of the Three-Dimensional Object Printing Apparatus

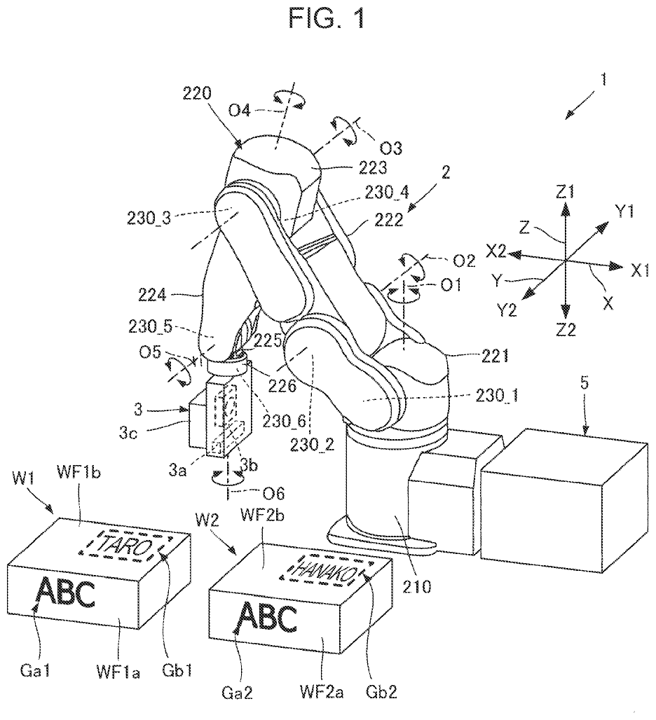

FIG. 1 is a perspective view schematically illustrating a three-dimensional object printing apparatus 1 according to an embodiment. The three-dimensional object printing apparatus 1 performs printing on surfaces of a plurality of three-dimensional workpieces by an ink jet method. In the example illustrated in FIG. 1, a first workpiece W1 and a second workpiece W2 are used as the plurality of workpieces.

The first workpiece W1 and second workpiece W2 have the same shape. In the example in FIG. 1, the first workpiece W1 and second workpiece W2 are each a rectangular parallelepiped. The first workpiece W1 has a first surface WF1a and a second surface WF1b oriented in a different direction from the first surface WF1a. Similarly, the second workpiece W2 has a first surface WF2a and a second surface WF2b oriented in a different direction from the first surface WF2a. The first surface WF1a and first surface WF2a are oriented in the Y2 direction. The second surface WF1b and second surface WF2b are oriented in the Z1 direction.

A case will be exemplified below in which a first common image Ga1 is printed on the first surface WF1a; a first substitute image Gb1 is printed on the second surface WF1b; a second common image Ga2 is printed on the first surface WF2a; and a second substitute image Gb2 is printed on the second surface WF2b. Although described later in detail, the first common image Ga1 and second common image Ga2 are the same. The first common image Ga1 and second common image Ga2 are each an example of a common image and are also each an example of a single image, which will be described later; each of them is created from a single piece of image data. The first substitute image Gb1 and second substitute image Gb2 are at least partially different from each other. The first substitute image Gb1 and second substitute image Gb2 are each an example of a combined image; each of them is created from a plurality of pieces of image data.

The surfaces, eligible for printing, on the first workpiece W1 and second workpiece W2 are not limited the surfaces described above. Any surfaces of the first workpiece W1 and second workpiece W2 are eligible for printing. Three or more surface of each of the first workpiece W1 and second workpiece W2 may be eligible for printing. The size and shape of the first workpiece W1 and second workpiece W2 and their attachment position or attachment orientation are arbitrary without being limited to the example in FIG. 1. The first workpiece W1 and second workpiece W2 may have mutually different shapes. The number of workpieces eligible for printing may be three or more without being limited to two. That is, in addition to the first workpiece W1 and second workpiece W2, one or more workpieces may be included as a third workpiece and the like.

The three-dimensional object printing apparatus 1 has the robot 2 described above, a head unit 3, and a controller 5 as illustrated in FIG. 1. First, these members will be simply described below in sequence.

The robot 2 changes the position and orientation of the head unit 3 in the world coordinate system. In the example in FIG. 1, the robot 2 is a so-called six-axis vertical articulated robot.

The robot 2 has a base 210 and an arm section 220 as illustrated in FIG. 1.

The base 210 is a pedestal that supports the arm section 220. In the example in FIG. 1, the base 210 is fixed to a floor surface oriented in the Z1 direction or to the attachment surface of a foundation or the like by, for example, being screwed. The attachment surface to which to fix the base 210 may be oriented in any direction, without being limited to the example in FIG. 1. For example, the attachment surface may be a surface of a wall, a ceiling, a movable dolly, or the like.

The arm section 220 is a six-axis robot arm having a bottom end attached to the base 210 and a top end, the position and orientation of which are three-dimensionally changed with respect to the bottom end. Specifically, the arm section 220 has arms 221, 222, 223, 224, 225, and 226, which are also referred to as links. These arms are linked in that order.

The arm 221 is linked to the base 210 through an articulation 230_1 so as to be swingable around a swing axis O1. The arm 222 is linked to the arm 221 through an articulation 230_2 so as to be swingable around a swing axis O2. The arm 223 is linked to the arm 222 through an articulation 230_3 so as to be swingable around a swing axis O3. The arm 224 is linked to the arm 223 through an articulation 230_4 so as to be swingable around a swing axis O4. The arm 225 is linked to the arm 224 through an articulation 230_5 so as to be swingable around a swing axis O5. The arm 226 is linked to the arm 225 through an articulation 230_6 so as to be swingable around a swing axis O6.

Each of the articulations 230_1 to 230_6 has a mechanism that swingably links one of two mutually adjacent members of the base 210 and arms 221 to 226 to the other. In the description below, each of the articulations 230_1 to 230_6 may also be referred to as the articulations 230.

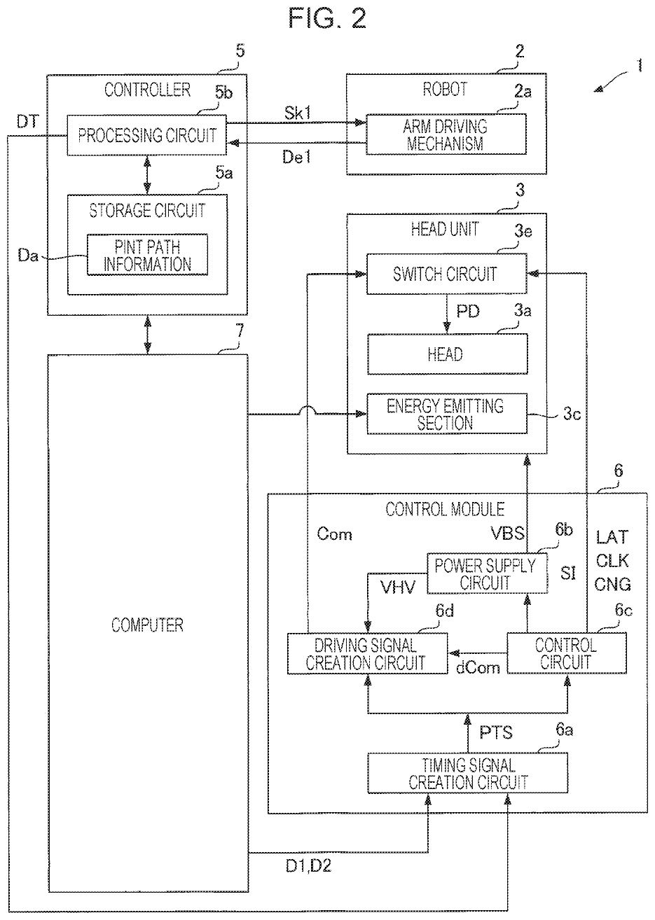

Although not illustrated in FIG. 1, each of the articulations 230_1 to 230_6 has a driving mechanism that swings one of the two relevant adjacent members with respect to the other. The driving mechanism has, for example, a motor that generates a driving force with which the one member is swung, a speed reducer that reduces the driving force and outputs the reduced force, and an encoder, such as a rotary encoder, that detects the amount of operation, such as the angle of the swing. An assembly of the driving mechanisms of the articulations 230_1 to 230_6 is equivalent to an arm driving mechanism 2a illustrated in FIG. 2, which will be referenced later.

The swing axis O1 is perpendicular to an attachment surface, which is not illustrated, to which the base 210 is fixed. The swing axis O2 is perpendicular to the swing axis O1. The swing axis O3 is parallel to the swing axis O2. The swing axis O4 is perpendicular to the swing axis O3. The swing axis O5 is perpendicular to the swing axis O4. The swing axis O6 is perpendicular to the swing axis O5.

The term “perpendicular” used for these swing axes not only refers to that an angle formed by two swing axes is strictly 90° but also refers to an angle formed by two swing axes deviates from 90° within a range of about ±5°. Similarly, the term “parallel” not only refers to that two swing axes are strictly parallel but also refers to that one of the two swing axes is inclined with respect to the other within a range of about ±5°.

The head unit 3 is attached to the arm 226, which is positioned at the extreme top end of the arm section 220 of the robot 2 described above, as an end effector in a state in which the head unit 3 is fixed by, for example, being screwed.

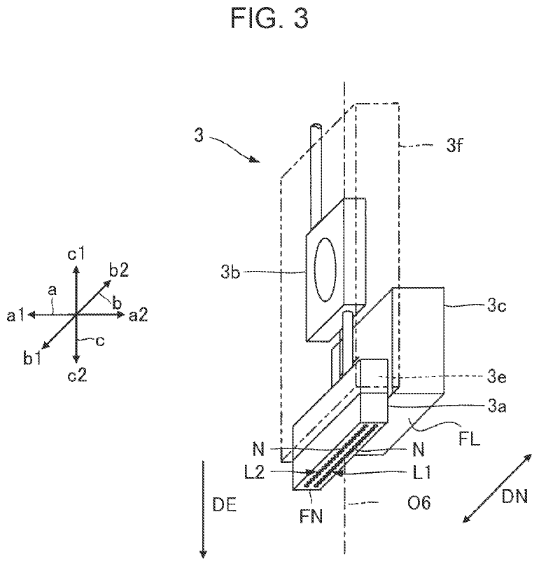

The head unit 3 is an assembly having a head 3a from which an ink, which is an example of a liquid, is discharged toward a workpiece W. In this embodiment, the head unit 3 has a pressure adjustment valve 3b and an energy emitting section 3c, besides the head 3a. The head unit 3 will be described later in detail with reference to FIG. 3.

There is no particular limitation on the ink. Examples of the ink include an aqueous ink resulting from dissolving a color material such as a dye or a pigment into an aqueous solvent, a curable ink based on a curable resin such as an ultraviolet curable resin, and a solvent-based ink resulting from dissolving a color material such as a dye or a pigment into an organic solvent. Of these inks, a curable ink is preferably used. There is no particular limitation on the curable ink. For example, the curable ink may be any of a heat-curable ink, a photo-curable ink, a radiation-curable ink, an electron-beam-curable ink, and the like. However, a photo-curable ink such as an ultraviolet curable ink or the like is preferable. The ink is not limited to a solution. The ink may be an ink resulting from dispersing a color material or the like in a dispersant as a dispersoid. The ink is not also limited to an ink including a color material. The ink may be, for example, an ink including, as a dispersoid, conductive particles, such as meal particles, used to form wiring. Alternatively, the ink may be a clear ink or a treatment liquid used in surface treatment on the workpiece W.

The controller 5 is a robot controller that controls the driving of the robot 2. The electric structure of the three-dimensional object printing apparatus 1 will be described below with reference to FIG. 2. The controller 5 will also be described below in detail.

### 1-2. Electric Structure of the Three-Dimensional Object Printing Apparatus

FIG. 2 is a block diagram illustrating the electric structure of the three-dimensional object printing apparatus 1 according to the embodiment. Of the constituent elements of the three-dimensional object printing apparatus 1, electric constituent elements are illustrated in FIG. 2. As illustrated in FIG. 2, the three-dimensional object printing apparatus 1 has a control module 6 coupled to the controller 5 so that communication is possible, and also has a computer 7 coupled to the controller 5 and control module 6 so that communication is possible, besides the constituent elements illustrated in FIG. 1 referenced above.

Each electric constituent element in FIG. 2 may be appropriately divided. Alternatively, part of each electric constituent element may be included in another constituent element. Alternatively, each electric constituent element may be formed integrally with another constituent element. For example, part or all of the functions of the controller 5 or control module 6 may be implemented by the computer 7 or may be implemented by a personal computer (PC) or another external device coupled to the controller 5 through a local area network (LAN), the Internet, or another internet.

The controller 5 has a function that controls the driving of the robot 2 and a function that creates a signal DT used to synchronize the ink discharge operation in the head unit 3 with the operation of the robot 2.

The controller 5 has a storage circuit 5a and a processing circuit 5b.

The storage circuit 5a stores various programs to be executed by the processing circuit 5b as well as various types of data to be processed by the processing circuit 5b. The storage circuit 5a includes one or both of a volatile memory, which is a type of semiconductor memory, such as a random-access memory (RAM) or the like and a non-volatile memory, which is also a type of semiconductor memory, such as a read-only memory (ROM), an electrically erasable programmable read-only memory (EEPROM), a programmable ROM (PROM), or the like. The storage circuit 5a may be partially or completely included in the processing circuit 5b.

Print path information Da is stored in the storage circuit 5a. Print path information Da, which is used in the control of the operation of the robot 2, indicates the positions and orientations of the head 3a on a path through which to move the head 3a. Print path information Da is represented by, for example, using coordinate values in a base coordinate system or a world coordinate system. Print path information Da is created by the computer 7 according to, for example, three-dimensional data Db indicating the shape of the workpiece W. Print path information Da is entered from the computer 7 into the storage circuit 5a. Print path information Da may be represented by using coordinate values in a workpiece coordinate system. In this case, after the conversion of coordinate values in the workpiece coordinate system to coordinate values in the base coordinate system or world coordinate system, print path information Da is used in the control of the operation of the robot 2.

The processing circuit 5b controls the operation of the arm driving mechanism 2a of the robot 2 according to print path information Da, and also creates the signal DT. The processing circuit 5b includes at least one processor such as a central processing unit (CPU). The processing circuit 5b may include a programmable logic device such as a field-programmable gate array (FPGA), instead of the CPU or in addition to the CPU.

The arm driving mechanism 2a is an assembly of the driving mechanisms of the articulations 230_1 to 230_6 described above. For each articulation 230 of the robot 2, the arm driving mechanism 2a has a motor used to drive the articulation 230 as well as an encoder that detects the rotational angle of the articulation 230.

The processing circuit 5b performs inverse kinematics calculation, by which print path information Da is converted to the amount of operation of each articulation 230 of the robot 2, such as the rotational angle, rotational speed, and the like. The processing circuit 5b then outputs a control signal Sk1 according to an output De1 from each encoder in the arm driving mechanism 2a, so that the actual amount of operation of each articulation 230 such as the rotational angle, rotational speed, and the like matches the results of the above calculation performed according to print path information Da. The control signal Sk1 controls the driving of the relevant motor in the arm driving mechanism 2a. The control signal Sk1 is compensated as necessary by the processing circuit 5b, according to an output from a distance sensor, which is not illustrated.

The processing circuit 5b creates the signal DT according to the output De1 from at least one of a plurality of encoders in the arm driving mechanism 2a. For example, the processing circuit 5b creates, as the signal DT, a trigger signal including a pulse at a timing when the output De1 from the at least one of the plurality of encoders becomes a predetermined value.

The control module 6 is a circuit that controls the ink discharge operation in the head unit 3 according to the signal DT output from the controller 5 and to first print data D1 and second print data D2 from the computer 7. The control module 6 has a timing signal creation circuit 6a, a power supply circuit 6b, a control circuit 6c, and a driving signal creation circuit 6d.

The timing signal creation circuit 6a creates a timing signal PTS according to the signal DT. The timing signal creation circuit 6a includes a timer that starts the creation of the timing signal PTS when, for example, the signal DT is detected.

The power supply circuit 6b receives a supply of electric power from a commercially available power source, which is not illustrated, and creates various predetermined potentials. Each created potential is appropriately supplied to various sections in the control module 6 and head unit 3. For example, the power supply circuit 6b creates a power supply potential VHV and an offset potential VBS. The offset potential VBS is supplied to the head unit 3. The power supply potential VHV is supplied to the driving signal creation circuit 6d.

The control circuit 6c creates a control signal SI, a waveform selection signal dCom, a latch signal LAT, a clock signal CLK, and a change signal CNG, according to the timing signal PTS. These signals are synchronized with the timing signal PTS. Of these signals, the waveform selection signal dCom is entered into the driving signal creation circuit 6d. The other signals are entered into a switch circuit 3e in the head unit 3.

The control signal SI is a digital signal used to specify the operation state of a driving element included in the head 3a in the head unit 3. Specifically, the control signal SI specifies whether to supply a driving signal Com, which will be described later, to the driving element, according to the first print data D1 or second print data D2. Due to this specification, whether to discharge ink from the nozzle corresponding to the driving element is specified or the amount of ink to be discharged from the nozzle is specified, for example. The waveform selection signal dCom is a digital signal used to stipulate the waveform of the driving signal Com. The latch signal LAT and change signal CNG, each of which is used together with the control signal SI, stipulate a timing to drive the driving element to stipulate a timing to discharge ink from the nozzle. The clock signal CLK functions as a reference synchronized with the timing signal PTS.

The control circuit 6c described above includes, for example, at least one processor such as a CPU. The control circuit 6c may include a programmable logic device such as an FPGA, instead of the CPU or in addition to the CPU.

The driving signal creation circuit 6d creates the driving signal Com used to drive each driving element in the head 3a in the head unit 3. Specifically, the driving signal creation circuit 6d has a digital-analog (DA) conversion circuit and an amplifier circuit, for example. In the driving signal creation circuit 6d, the DA conversion circuit converts the waveform selection signal dCom sent from the control circuit 6c from digital to analog, and the amplifier circuit amplifies the resulting analog signal by using the power supply potential VHV sent from the power supply circuit 6b to create the driving signal Com. A signal having a waveform that is actually supplied to the driving element, the waveform being one of the waveforms included in the driving signal Com, is a driving pulse PD. The driving pulse PD is supplied from the driving signal creation circuit 6d through the switch circuit 3e in the head unit 3 to the driving element.

The switch circuit 3e includes a switching element that selectively supplies, as the driving pulse PD, at least part of the waveforms included in the driving signal Com according to the control signal SI.

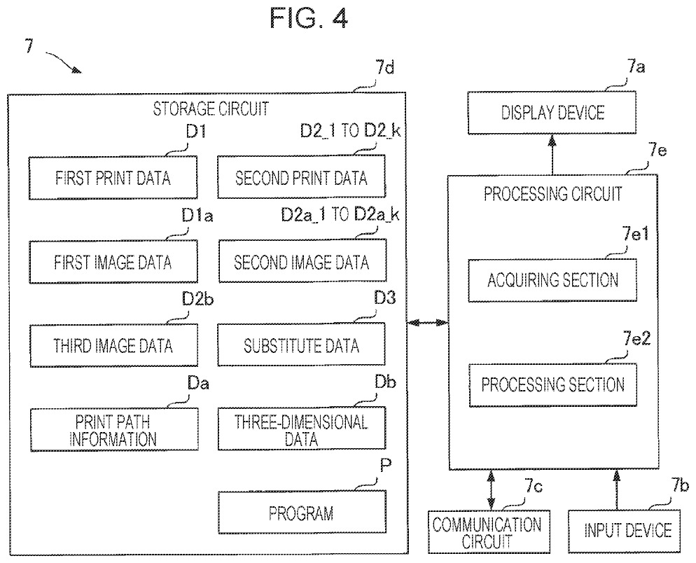

The computer 7 is a desktop computer, a note computer, or the like in which a program P and other programs are installed. The computer 7 has a function that creates first print data D1, second print data D2, and print path information Da, a function that supplies print path information Da and the like to the controller 5, and a function that supplies first print data D1, second print data D2, and other information to the control module 6. In addition to these functions, the computer 7 in this embodiment has a function that controls the driving of the energy emitting section 3c. The computer 7 will be described later in detail with reference to FIG. 4.

### 1-3. Structure of the Head Unit

FIG. 3 is a perspective view schematically illustrating the structure of the head unit 3. For convenience, an a-axis, a b-axis, and a c-axis, which are mutually orthogonal, will be used in the description below. In the description below, a direction along the a-axis is an a1 direction and a direction opposite to the a1 direction is an a2 direction. Similarly, directions that are along the b-axis and are mutually opposite are a b1 direction and a b2 direction. Similarly, directions that are along the c-axis and are mutually opposite are a c1 direction and a c2 direction.

The a-axis, b-axis, and c-axis are equivalent to the coordinate axes in a tool coordinate system set in the head unit 3. The positional relationship and orientational relationship change relative to the world coordinate system or robot coordinate system described above, depending on the operation of the robot 2 described above. In the example in FIG. 3, the c-axis is parallel to the swing axis O6 described above. Typically, the a-axis, b-axis, and c-axis are mutually orthogonal. However, this is not a limitation. For example, the a-axis, b-axis, and c-axis only need to cross one another at angles of 80° to 100°. A correspondence is made between the tool coordinate system and the base coordinate system or robot coordinate system through calibration.

The tool coordinate system is set with respect to a tool center point. Therefore, the position and orientation of the head 3a are stipulated with respect to the tool center point. For example, the tool center point may be set at the center of a discharge surface FN or may be set at a position in a space, the position being distant from the head 3a in a discharge direction DE of ink.

As described above, the head unit 3 has the head 3a, pressure adjustment valve 3b, and energy emitting section 3c. These members are supported by a support body 3f indicated by the double-dot-dashed lines in FIG. 3. In the example in FIG. 3, one head 3aand one pressure adjustment valve 3b are included in the head unit 3. However, the number of heads 3a and the number of pressure adjustment valves 3b are not limited to the example in FIG. 3. Two or more heads 3a and two or more pressure adjustment valves 3b may be included. The position to which to attach the pressure adjustment valve 3b is not limited to the arm 226. For example, the pressure adjustment valve 3b may be attached to another arm or the like. Alternatively, the pressure adjustment valve 3b may be attached to a position fixed with respect to the base 210.

The support body 3f, which is substantially a rigid body, is formed from, for example, a metal material or the like. In FIG. 3, the support body 3f is shaped like a flat box. However, there is no particular limitation on the shape of the support body 3f. The support body 3f has any shape.

The support body 3f is attached to the arm 226 described above. That is, the head 3a, pressure adjustment valve 3b, and energy emitting section 3c are supported together by the arm 226 through the support body 3f. Therefore, the positions of the head 3a, pressure adjustment valve 3b, and energy emitting section 3c are fixed relative to the arm 226. In the example in FIG. 3, the pressure adjustment valve 3b is placed at a position in the c1 direction with respect to the head 3a, and the energy emitting section 3c is placed at a position in the a2 direction with respect to the head 3a.

The head 3a has the discharge surface FN and a plurality of nozzles N, each of which has an opening in the discharge surface FN. The discharge surface FN is a nozzle surface, in which the openings of the nozzles N are formed. The discharge surface FN is, for example, a surface of a nozzle plate that is formed by forming nozzles N as through-holes in a plate-like member formed from silicon (Si), metal, or another material. In the example in FIG. 3, a direction along the normal of the discharge surface FN, that is, the discharge direction DE, in which ink is discharged from the nozzles N, is the c2 direction. The plurality of nozzles N are divided into a nozzle row L1 and a nozzle row L2, which are arranged in a direction along the a-axis so as to be spaced. The nozzle row L1 and nozzle row L2 are each a set of a plurality of nozzles N linearly arranged in a direction along the b-axis. In the head 3a, elements related to the nozzles N of the nozzle row L1 and elements related to the nozzles N of the nozzle row L2 are substantially symmetric with respect to a direction along the a-axis. An arrangement direction DN, which will be described later, is parallel to the b-axis.

There may be a match between the positions of the plurality of nozzles N in the nozzle row L1 and the positions of the plurality of nozzles N in the nozzle row L2 in a direction along the b-axis, or there may be no match between these positions. Elements related to the nozzles N in one of the nozzle row L1 and nozzle row L2 may be omitted. In the description below, a structure will be exemplified in which there is a match between the positions of the plurality of nozzles N in the nozzle row L1 and the positions of the plurality of nozzles N in the nozzle row L2 in a direction along the b-axis.

Although not illustrated, the head 3a has a piezoelectric element, which is a driving element, and a cavity in which ink is stored for each nozzle N. The piezoelectric element changes pressure in the cavity corresponding to the piezoelectric element to discharge ink from the nozzle N corresponding to the cavity in the discharge direction DE. This type of head 3a is obtained by bonding, with an adhesive, a plurality of silicon substrates or other substrates that have been appropriately machined by, for example, etching. As the driving element used to discharge ink from the nozzle N, a heater may be used to heat ink in the cavity, instead of using the piezoelectric element.

The head 3a described above receives a supply of ink from an ink tank, which is not illustrated, through the pressure adjustment valve 3b.

The pressure adjustment valve 3b is a valve mechanism that is opened and closed according to the pressure of ink in the head 3a. Due to this opening and closing, the pressure of ink in the head 3a is maintained at a negative value within a predetermined range even when the positional relation between the head 3a and the ink tank, which is not illustrated, changes. Therefore, ink meniscus formed in the nozzle N of the head 3a is stabilized. This prevents from bubbles from entering the nozzle N and also prevents ink from overflowing from the nozzle N. Ink exiting from the pressure adjustment valve 3b is appropriately branched to a plurality portions in the head 3a through a branch path, which is not illustrated. Ink exiting from the ink tank, which is not illustrated, is supplied to the pressure adjustment valve 3b under prescribed pressure by a pump or the like.

The energy emitting section 3c emits light, heat, electron beams, nuclear radiation, or other energy used to cure or solidify ink on the workpiece W. When, for example, ink has an ultraviolet curable property, the energy emitting section 3c includes, for example, light-emitting elements, such as light emitting diodes (LEDs), that emit ultraviolet rays. The energy emitting section 3c may appropriately have, for example, a lens or another optical part used to adjust the energy emission direction, an emission range, or the like.

The energy emitting section 3c may not completely cure or solidify ink on the workpiece W. In this case, it is only necessary to use, for example, energy from a light source for use for curing, the light source being separately provided on the attachment surface of the base 210 of the robot 2, to completely cure or solidify ink to which energy has been emitted from the energy emitting section 3c.

### 1-4. Computer

FIG. 4 illustrates the computer 7 used in the three-dimensional object printing apparatus 1 according to the embodiment. The computer 7 has a display device 7a, an input device 7b, a communication circuit 7c, a storage circuit 7d, and a processing circuit 7e, as illustrated in FIG. 4. These members are coupled so that communication is possible among them.

The display device 7a displays various images under control of the processing circuit 7e. The display device 7a has one of various panels such as, for example, a crystal display panel and an organic electro-luminescence (EL) display panel. The display device 7a may be provided outside the computer 7.

The input device 7b accepts a manipulation by the user. The input device 7b has, for example, a touch pad, a touch panel, a mouse, or another pointing device. When the input device 7b has a touch panel, the input device 7b may double as the display device 7a. The input device 7b may be provided outside the computer 7.

The communication circuit 7c is a communication device coupled to the energy emitting section 3c, controller 5, and control module 6 so that communication is possible. The communication circuit 7c has interfaces such as, for example, a Universal Serial Bus (USB) interface and a LAN interface. The communication circuit 7c may be wirelessly coupled to the controller 5, control module 6, and the like by Wi-Fi, Bluetooth, or the like. Alternatively, the communication circuit 7c may be coupled to the controller 5, control module 6, and the like through a LAN, the Internet, or another network.

The storage circuit 7d stores various programs to be executed by the processing circuit 7e as well as various types of data to be processed by the processing circuit 7e. The storage circuit 7d includes one or both of a volatile memory, which is a type of semiconductor memory, such as a RAM or the like and a non-volatile memory, which is also a type of semiconductor memory, such as a ROM, an EEPROM, a PROM, or the like. The storage circuit 7d may be partially or completely included in the processing circuit 7e.

The storage circuit 7d stores print path information Da, three-dimensional data Db, first print data D1, second print data D2_1 to D2_k, first image data D1a, second image data D2a_1 to D2a_k, third image data D2b, substitute data D3, and the program P. The letter k is a natural number more than or equal to 2, and is equivalent to the number of workpieces eligible for printing.

In this embodiment, the number of workpieces eligible for printing is 2, so k is 2. In the description below, an example in which k is 2 will be described. Also in the description below, each of second print data D2_1 to D2_k may be referred to as second image data D2; and each of second image data D2a_1 to D2a_k may be referred to as second image data D2a. Since the number of workpieces eligible for printing may be 3 or more, k may be 3 or more.

Three-dimensional data Db represents the three-dimensional shapes of the first workpiece W1 and second workpiece W2. There is no particular limitation on the format of three-dimensional data Db. For example, three-dimensional data Db is in Standard Triangulated Language (STL) format or the like. Three-dimensional data Db is obtained by performing conversion processing on computer-aided design (CAD) data as necessary. Three-dimensional data Db may be represented by using coordinate values in the workpiece coordinate system or may be presented by using coordinate values in the base coordinate system or world coordinate system.

First image data D1 is used in printing on both the first workpiece W1 and the second workpiece W2 in common. First image data D1 is created from first image data D1a in a format that can be processed by the control module 6. Specifically, first print data D1 is obtained by processing first image data D1a. The processing includes at least one of color conversion processing, density correction processing, quantization processing, distribution processing, raster image processor process (RIP) processing, and other image processing.

Second print data D2_1 is image data used for individual printing on the first workpiece W1. Second print data D2_1 is created from second image data D2a_1 and third image data D2b in a format that can be processed by the control module 6. Specifically, second print data D2_1 is obtained by processing second image data D2a_1 and third image data D2b. The processing includes at least one of processing for combining an image indicated by second image data D2a_1 and an image indicated by third image data D2b together, color conversion processing, density correction processing, quantization processing, distribution processing, RIP processing, and other image processing.

Second print data D2_2 is image data used for individual printing on the second workpiece W2. Second print data D2_2 is created from second image data D2a_2 and third image data D2b in a format that can be processed by the control module 6. Specifically, second print data D2_2 is obtained by processing second image data D2a_2 and third image data D2b. The processing includes at least one of processing for combining an image indicated by second image data D2a_2 and an image indicated by third image data D2b together, color conversion processing, density correction processing, quantization processing, distribution processing, RIP processing, and other image processing.

First image data D1a indicates both first common image Ga1 and second common image Ga2. Second image data D2a_1 indicates a substitute for part of first substitute image Gb1. Second image data D2a_2 indicates a substitute for part of second substitute image Gb2. Third image data D2b indicates a portion common to first substitute image Gb1 and second substitute image Gb2. These pieces of image data are in, for example, bitmap format such as Joint Photographic Experts Group (JPEG), PostScript format, Portable Document Format (PDF), Extensible Markup Language (XML) Paper Specification (XPS) format, or another vector format.

Substitute data D3 is used to create second image data D2a_1 and D2a_2. Substitute data D3 has information about the substitute for part of first substitute image Gb1. Information about the substitute is arbitrary without being limited. In this embodiment, information in the substitute is a name and a blood type, as will be described later. However, an address, the lot number of a product, and the like can be appropriately set according to the purpose. Examples of first image data D1a include data related to the logo of a brand, the name and model of a product, and the like. However, appropriate data can be set according to the purpose.

The program P is used to create print path information Da, first print data D1, and second print data D2_1 to D2_n. The program P may be divided into two or more programs. For example, the program P may be divided into a program that creates print path information Da and a program that creates first print data D1 and second print data D2_1 to D2_n.

When the program P or another program is executed, the processing circuit 7e implements various functions described above. The processing circuit 7e includes, for example, at least one processor such as a CPU. The processing circuit 7e may include a programmable logic device such as an FPGA, instead of the CPU or in addition to the CPU.

When the program P is executed, the processing circuit 7e functions as an acquiring section 7e1 and a processing section 7e2.

The acquiring section 7e1 acquires various types of information needed for processing in the processing section 7e2. Specifically, the acquiring section 7e1 acquires first image data D1a, third image data D2b, and substitute data D3 as information needed to create first print data D1 and second print data D2_1 to D2_k in the processing section 7e2. The acquiring section 7e1 also acquires three-dimensional data Db as information needed to create print path information Da in the processing section 7e2.

In this embodiment, the acquiring section 7e1 displays, on the display device 7a, an image UI used as a graphical user interface (GUI), which will be described later, and acquires first image data D1a, third image data D2b, substitute data D3, and three-dimensional data Db according to the user input to the input device 7b.

The processing section 7e2 processes the information acquired by the acquiring section 7e1. Specifically, the processing section 7e2 creates print path information Da from three-dimensional data Db. There is no particular limitation on the method of this creation. Any method can be used.

The processing section 7e2 creates first print data D1 from first image data D1a. Specifically, the processing section 7e2 creates first print data D1 by performing image processing on first image data D1a.

The processing section 7e2 further creates second image data D2a_1 to D2a_k from substitute data D3. Then, the processing section 7e2 creates second print data D2_1 to D2_k from second image data D2a_1 to D2a_k and third image data D2b. Here, the processing section 7e2 creates second print data D2_1 to D2_k by performing combining processing and image processing on second image data D2a_1 and third image data D2b. The processing section 7e2 may have a function for determining a print sequence. In this case, the processing section 7e2 determines a print sequence for images according to whether an image to be printed on the relevant surface WF of the workpiece W is a combined image or a single image.

### 1-5. Operation of the Three-Dimensional Object Printing Apparatus

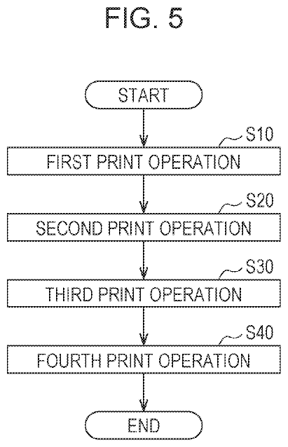

FIG. 5 illustrates a flow of operations of the three-dimensional object printing apparatus 1 according to the embodiment. The three-dimensional object printing apparatus 1 executes a first print operation S10, a second print operation S20, a third print operation S30, and a fourth print operation S40 in that order, as illustrated in FIG. 5. That is, the three-dimensional object printing method executed by the three-dimensional object printing apparatus 1 includes the first print operation S10, second print operation S20, third print operation S30, and fourth print operation S40. The three-dimensional object printing apparatus 1 executes these print operations in that order. In the description below, each of these print operations may be simply referred to as the print operation.

In the first print operation S10, the first common image Ga1 is printed on the first workpiece W1 by using first print data D1. In this embodiment, the first common image Ga1 is printed on the first surface WF1a of the first workpiece W1, as described above.

During the execution of the first print operation S10, the processing section 7e2 executes processing for creating or acquiring second image data D2a_1 and third image data D2b, which are for use for the first substitute image Gb1 to be printed in the second print operation S20.

Then, during the execution of the first print operation S10, the processing section 7e2 executes processing for creating second print data D2_1, which is an example of data indicating a combined image, by combining second image data D2a_1 and third image data D2b, which are an example of a plurality of pieces of image data. Also during the execution of the first print operation S10, the acquiring section 7e1 executes processing for acquiring substitute data D3, which is an example of data related to a combined image.

In the second print operation S20, the first substitute image Gb1 is printed on the first workpiece W1 by using second print data D2_1. In this embodiment, the first substitute image Gb1 is printed on the second surface WF1b of the first workpiece W1, as described above.

In the third print operation S30, the second common image Ga2 is printed on the second workpiece W2 by using first print data D1. In this embodiment, the second common image Ga2 is printed on the first surface WF2a of the second workpiece W2, as described above.

During the execution of the second print operation S20 on the first workpiece W1 or the execution of the third print operation S30 on the second workpiece W2, the processing section 7e2 executes processing for creating or acquiring second image data D2a_2 and third image data D2b, which are for use for the second substitute image Gb2 to be printed in the fourth print operation S40.

Then, during the execution of the second print operation S20 on the first workpiece W1 or the execution of the third print operation S30 on the second workpiece W2, the processing section 7e2 executes processing for creating second print data D2_2, which is another example of data indicating a combined image, by combining second image data D2a_2 and third image data D2b, which are another example of a plurality of pieces of image data. Also during the execution of the second print operation S20 on the first workpiece W1 or the execution of the third print operation S30 on the second workpiece W2, the acquiring section 7e1 executes processing for acquiring substitute data D3, which is another example of data related to a combined image.

In the fourth print operation S40, the second common image Ga2 is printed on the second workpiece W2 by using second print data D2_2. In this embodiment, the second substitute image Gb2 is printed on the second surface WF2b of the second workpiece W2, as described above.

In printing in which a plurality of print operations are performed on the first workpiece W1 in sequence, the second print operation S20 is executed last among the plurality of print operations.

When n first images, n being a natural number more than or equal to 1, each of which is a single image, and m second images, m being a natural number more than or equal to 1, each of which is a combined image, are printed on the first workpiece W1 or second workpiece W2, n print operations to print the n first images are all executed before m print operations to print the m second images are executed.

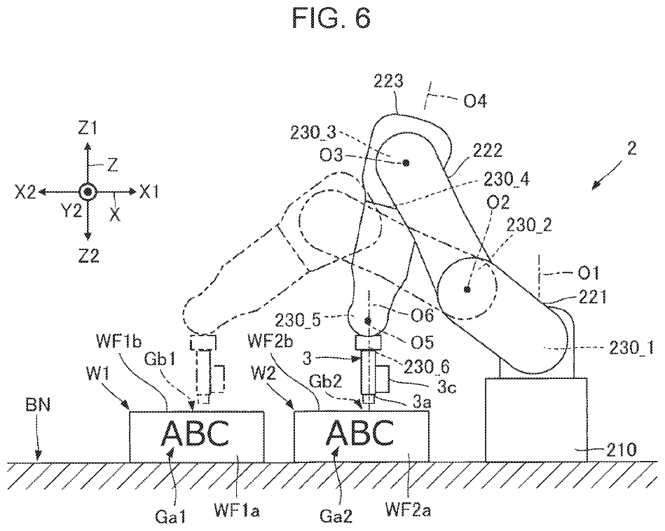

FIG. 6 illustrates of a printing operation of the three-dimensional object printing apparatus 1 according to the embodiment. In FIG. 6, the state of the robot 2 during the execution of the fourth print operation S40 is illustrated, and the state of the robot 2 during the execution of the second print operation S20 is also illustrated with double-dot-dashed lines.

In the example in FIG. 6, the second workpiece W2 and first workpiece W1 are positioned in the X2 direction away from the robot 2, in that order.

In a print operation, the head 3a discharges ink while the robot 2 changes the position and orientation of the head 3a. The position and orientation of the head 3a are changed according to print path information Da. Thus, the head 3a moves along a movement path based on print path information Da while the head 3a keeps a predetermined orientation with respect to the surface, eligible for printing, of the first workpiece W1 or second workpiece W2.

### 1.6. Single Image and Combined Image

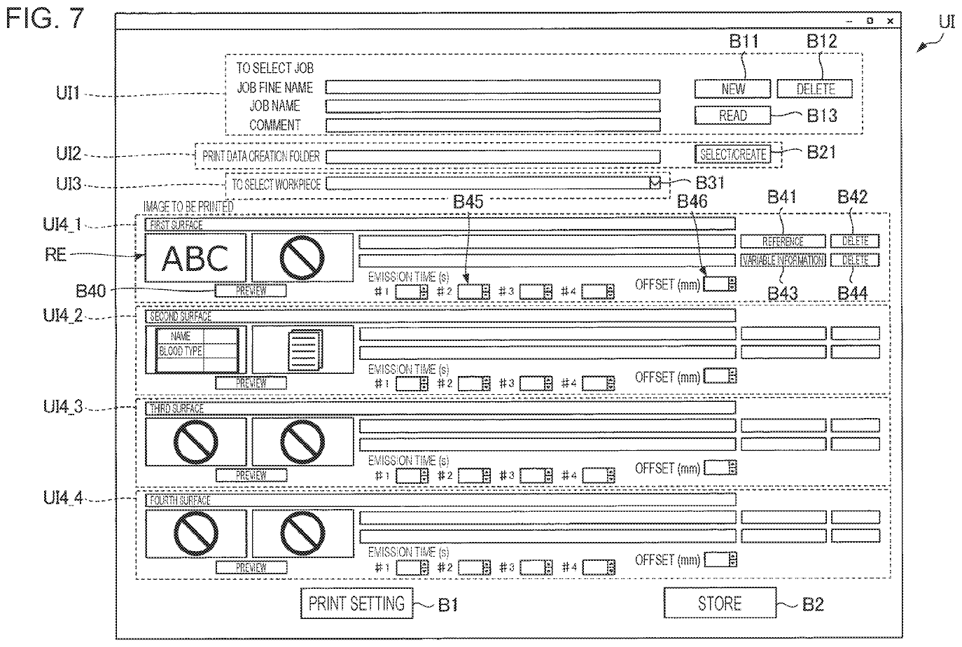

FIG. 7 illustrates an example of a display on which to set a single image and a combined image. The acquiring section 7e1 described above displays the image UI illustrated in FIG. 7 on the display device 7a. The image UI is a GUI used to enter various type of information needed to set
the first common image Ga1 and second common image Ga2, each of which is a single image, as well as the first substitute image Gb1 and second substitute image Gb2, each of which is a combined image. In the example in FIG. 7, the image UI has areas UI1, UI2, UI3, UI4_1 to UI4_4, and buttons B1 and B2.

In the area UI1, a job file in which settings are recorded is selected by using the image UI. The area UI1 includes buttons B11, B12, and B13. The button B11 specifies the file name of a job file to be newly created. When a manipulation is performed by using this button, the specified file name is displayed in the area UI1. The button B12 deletes the display of the job file. When a manipulation is performed by using this button, the display of the selected job file is deleted. The button B13 reads an existing job file. When a manipulation is performed by using this button, the file name of the read job file is displayed in the area UI1. In the example in FIG. 7, the area UI1 is ready for accepting a job name and a comment.

In the area UI2, the storage destination of first print data D1, second print data D2, or other print data is specified. The area UI2 includes a button B21. When a manipulation is performed by using this button, a path to the storage destination is displayed in the area UI2.

In the area UI3, three-dimensional data Db, which is information about the shapes of the first workpiece W1 and second workpiece W2, is specified or selected. In the example in FIG. 7, a pull-down menu is provided in the area UI3. A path to the storage destination of the specified or selected three-dimensional data Db is displayed.

In the areas UI4_1 to UI4_4, print conditions for a single image and combined image are set for each surface, eligible for printing, on the first workpiece W1 or second workpiece W2. The areas UI4_1 to UI4_4, are the same except that they indicate different surfaces, eligible for printing, of a workpiece. In the example in FIG. 7, the area UI4_1 is used to set print conditions for the first common image Ga1 and second common image Ga2; and the area UI4_2 is used to set print conditions for the first substitute image Gb1 and second substitute image Gb2. In the description below, each of the areas UI4_1 to UI4_4 may be referred to as the area UI4.

Each area UI4 includes buttons B41, B42, B43, B44, B45, B46 and B40, and an area RE. The button B41 specifies image data. When a manipulation is performed by using this button, a path to reference the specified image data is displayed in the area UI4 and a preview of the image data is displayed in the area RE. The button B42 deletes the display of the specified image data. When a manipulation is performed by using this button, the display of the specified first image data D1a is deleted. The button B43 specifies substitute data D3. When a manipulation is performed by using this button, a path to reference the specified substitute data D3 is displayed in the area UI4 and a thumbnail image of the substitute data D3 is displayed in the area RE. The button B44 deletes the display of the specified substitute data D3.

When substitute data D3 is not specified by manipulating the button B43, the image data specified by manipulating the button B41 is used as first image data D1a. By contrast, when substitute data D3 is specified by manipulating the button B43, the image data specified by manipulating the button B41 is used as third image data D2b.

In the area UI4_1 in the example in FIG. 7, first image data D1a is specified by manipulating the button B41 and substitute data D3 is not specified by manipulating the button B43. By contrast, in the area UI4_2, third image data D2b is specified by manipulating the button B41 and substitute data D3 is also specified by manipulating the button B43. In the area UI4_2, however, third image data D2b may not be specified by manipulating the button B41.

The button B45 specifies a time during which energy is emitted by the energy emitting section 3c and the number of emissions. When a manipulation is performed by using this button, a time during which energy is emitted by the energy emitting section 3c and the number of emissions are specified. The button B46 sets an offset of the print area. When a manipulation is performed by using this button, an offset of the print area is set.

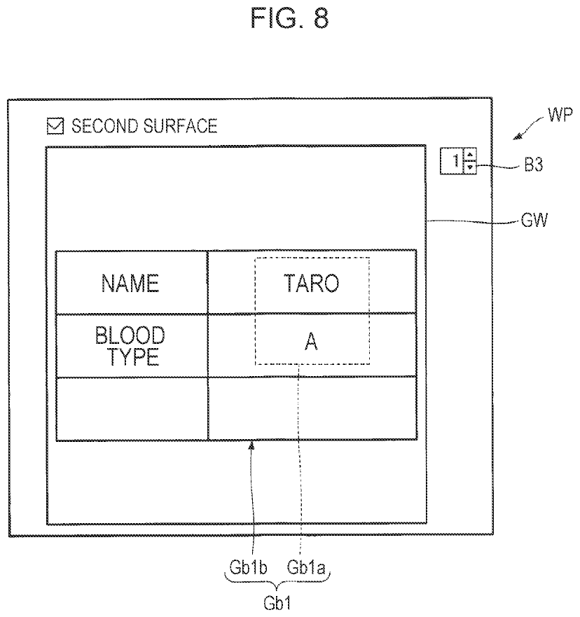

The button B40 displays a preview of the specified image data. When a manipulation is performed by using this button, a preview of the specified image data is displayed. Specifically, when substitute data D3 is not specified by manipulating the button B43, a preview of the image data specified by manipulating the button B41 is displayed. By contrast, when substitute data D3 is specified by manipulating the button B43, a preview of a combined image is displayed, the combined image being created from the first image data D1a specified by manipulating the button B41 and the second image data D2a based on the substitute data D3. A specific example of a preview display will be described later with reference to FIG. 8.

The button B1 sets various other print settings. When a manipulation is performed by using this button, various other print settings are set. The button B2 stores settings set by using the image UI as print conditions. When a manipulation is performed by using this button, settings set by using the image UI are stored as a print job. At this time, first print data D1 is created.

FIG. 8 illustrates an example a preview display for a combined image. In FIG. 8, a preview display for first substitute image Gb1, which is a combined image to be printed on the second surface WF1b, is illustrated as an example.

When the button B40 illustrated in FIG. 7 referenced above is manipulated, a window WP for a preview is displayed on the display device 7a as illustrated in FIG. 8. In the window WP, an area GW and a button B3 are provided. The area GW is used to display a preview.

First substitute image Gb1 includes an image Gb1a based on second image data D2a and also includes an image Gb1b based on third image data D2b. In the example in FIG. 8, the image Gb1a indicates a name and blood type, which are information based on substitute data D3, and the image Gb1b is a background image that ornaments the image Gb1a.

The button B3 specifies a workpiece to be previewed. When a manipulation is performed by using this button, a workpiece to be previewed is specified and a preview of an image to be printed on the specified workpiece is displayed in the area GW. In FIG. 8, for example, the first workpiece W1 is specified and the first substitute image Gb1 is displayed in the area GW. Therefore, it can be confirmed in advance that TARO and A will be respectively printed as a name and blood type. When second workpiece W2 is specified by using the button B3, the display in the area GW changes to the second substitute image Gb2. Therefore, it can be confirmed in advance that HANAKO and B will be respectively printed as a name and blood type.

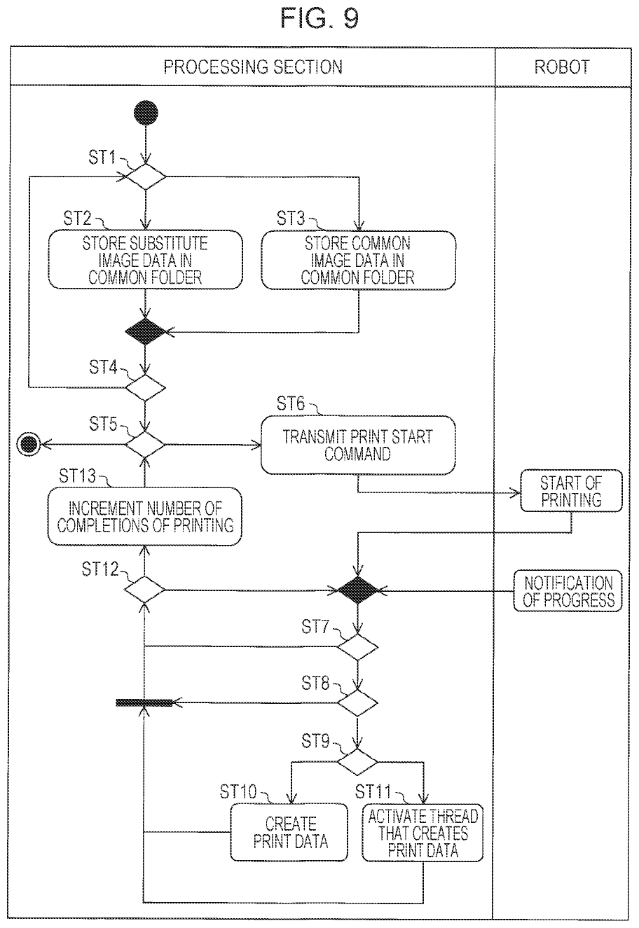

FIG. 9 illustrates a flow of data processing for a single image and combined image. The flow of data exemplified in FIG. 9 is from the start of print commanding after the completion of the setting of a single image and combined image to the termination of printing.

When printing is commanded, the processing section 7e2 first decides in step ST1 whether the surface on which to perform printing is a surface on which to print a combined image or a surface on which to print a single image, as illustrated in FIG. 9.

The surface on which to perform printing may be a surface on which to print a combined image. Then, when the surface is, for example, the second surface WF1b, the processing section 7e2 creates second print data D2 and stores the created second print data D2 in a predetermined folder in the storage circuit 7d in step ST2. The second print data D2 is a single piece of second print data D2_1 used for the first workpiece W1, which is a workpiece to be printed first.

The surface on which to perform printing may be a surface on which to print a single image. Then, when the surface is, for example, the first surface WF1a, the processing section 7e2 stores first print data D1 in the predetermined folder in the storage circuit 7d in step ST3, the first print data D1 having been created in advance when the print job described above was stored,.

After step ST2 or step ST3, the processing section 7e2 decides in step ST4 whether image data has been set for all surfaces, on which to perform printing, of one workpiece. When image data has not been set for all surfaces, on which to perform printing, of the one workpiece, the processing section 7e2 returns to step ST1 described above.

When image data has been set for all surfaces, on which to perform printing, of the one workpiece, the processing section 7e2 decides in step ST5 whether the number of workpieces on which printing has been completed has reached a target number. When the number of workpieces on which printing has been completed has reached the target number, the processing section 7e2 terminates the printing.

When the number of workpieces on which printing has been completed has yet to reach the target number, the processing section 7e2 transmits a print start command to the controller 5 and control module 6 in step ST6. Then, printing starts. The controller 5 notifies the processing section 7e2 of the progress of printing.

In step ST7, the processing section 7e2 decides whether the printing progress, the notification of which was sent from the controller 5, has reached 100% and also decides whether to change the surface on which to perform printing.

When the printing progress, the notification of which was sent from the controller 5, has not reached 100% and the surface on which to perform printing will not be changed, the processing section 7e2 shifts to step ST12, which will be described later.

When the printing progress, the notification of which was sent from the controller 5, has reached 100% or the surface on which to perform printing will be changed, the processing section 7e2 decides in step ST8 whether printing completed on the surface is printing of a combined image.

When printing completed on the surface is not printing of a combined image, the processing section 7e2 shifts to step ST12, which will be described later.

When printing completed on the surface is printing of a combined image, the processing section 7e2 decides in step ST9 whether one surface of the workpiece is eligible for printing or a plurality of its surfaces are eligible for printing. When one surface of the workpiece is eligible for printing, the processing section 7e2 creates print data in step ST10. When a plurality of surfaces of the workpiece are eligible for printing, the processing section 7e2 activates, in step ST11, a thread that creates print data.

After step ST10 or step ST11, the processing section 7e2 decides in step ST12 whether the printing progress, the notification of which was sent from the controller 5, has reached 100%. When the printing progress, the notification of which was sent from the controller 5, has yet to reach 100%, the processing section 7e2 returns to step ST7. When the printing progress, the notification of which was sent from the controller 5, has reached 100%, the processing section 7e2 increments the number of completions of printing in step ST13, after which the processing section 7e2 returns to step ST5.

As described above, the three-dimensional object printing apparatus 1 performs printing of the first common image Ga1 and first substitute image Gb1 on the first workpiece W1, which is a three-dimensional workpiece, and also performs printing of the second common image Ga2 and second substitute image Gb2 on the second workpiece W2, which is also a three-dimensional workpiece. As described above, the first common image Ga1 and second common image Ga2 are the same image. By contrast, the first substitute image Gb1 and second substitute image Gb2 are at least partially different from each other. The first common image Ga1 and second common image Ga2 are each an example of a single image. Each of these images is created from one piece of image data. By contrast, the first substitute image Gb1 and second substitute image Gb2 are each an example of a combined image. Each of these images is created from a plurality of pieces of image data.

In addition, the three-dimensional object printing apparatus 1 executes the first print operation S10, in which the first common image Ga1 is printed on the first workpiece W1, before executing the second print operation S20, in which the first substitute image Gb1 is printed on the first workpiece W1. This execution is an example of a three-dimensional object printing method.

With the three-dimensional object printing apparatus 1 or three-dimensional object printing method, since the first print operation S10 is executed before the second print operation S20 is executed, the first substitute image Gb1 can be acquired or created by combination during the execution of the first print operation S10. As a result, a time taken to print the first common image Ga1 and first substitute image Gb1 on the first workpiece W1 can be shortened when compared with a structure in which the second print operation S20 is executed before the first print operation S10 is executed.

Also, the three-dimensional object printing apparatus 1 executes the third print operation S30, in which the second common image Ga2 is printed on the second workpiece W2, before executing the fourth print operation S40, in which the second substitute image Gb2 is printed on the second workpiece W2, as described above. Therefore, the second substitute image Gb2 can be acquired or created by combination during the execution of the third print operation S30. As a result, a time taken to print the second common image Ga2 and second substitute image Gb2 on the second workpiece W2 can be shortened when compared with a structure in which the fourth print operation S40 is executed before the third print operation S30 is executed.

As described above, the three-dimensional object printing apparatus 1 executes the first print operation S10, second print operation S20, third print operation S30, and fourth print operation S40 in that order. Therefore, printing needed for the first workpiece W1 can be completed before printing needed for the second workpiece W2 is completed. As a result, it is possible to have the first workpiece W1 leave the working place for printing and supply the first workpiece W1 to a process other than printing before printing on the second workpiece W2 is completed.

As described above, the three-dimensional object printing apparatus 1 has the processing section 7e2 used to process image data. The processing section 7e2 executes processing for creating or acquiring image data indicating the second substitute image Gb2 during the execution of a print operation for the first workpiece W1. Therefore, it is possible to complete the processing for creating or acquiring image data indicating the second substitute image Gb2 before executing a print operation for the second workpiece W2. It is preferable for the processing section 7e2 to execute the processing for creating or acquiring image data indicating the second substitute image Gb2 during the execution of the second print operation S20. In this case, it is possible to prevent a period of processing for creating or acquiring image data indicating the second substitute image Gb2 from occurring at the same time as when a period of acquiring the first substitute image Gb1 or creating it by combination occurs. As a result, a processing load on the computer 7 is reduced, so processing for creating or acquiring image data indicating the second substitute image Gb2 can be speeded up.

As described above, the processing section 7e2 executes processing for creating second print data D2, which is an example of data indicating a combined image, by combing second image data D2a and third image data D2b, which are an example of a plurality of pieces of image data, during the execution of the first print operation S10. A long time is taken to combine a plurality of pieces of image data. However, when the processing for combining a plurality of pieces of image data is executed concurrently with the execution of the first print operation S10, the efficiency of processing can be enhanced.

As described above, the three-dimensional object printing apparatus 1 has the acquiring section 7e1 used to acquire image data. The acquiring section 7e1 executes processing for acquiring substitute data D3, which is an example of data related to a combined image, during the execution of the first print operation S10. A long time is taken to acquire data related to a combined image. However, when the processing for acquiring data related to a combined image is executed concurrently with the execution of the first print operation S10, the efficiency of processing can be enhanced.

As described above, the first workpiece W1 has the first surface WF1a and the second surface WF1b oriented in a different direction from the first surface WF1a. The first common image Ga1 is printed on the first surface WF1a. By contrast, the first substitute image Gb1 is printed on the second surface WF1b. Thus, mutually different images can be printed on two surfaces oriented in mutually different directions.

As described above, the processing section 7e2 creates first print data D1 by processing first image data D1a. Both the first common image Ga1 and the second common image Ga2 are printed by using first print data D1. Therefore, time taken to print the first common image Ga1 and second common image Ga2 can be shortened when compared with a structure in which processing for creating first print data D1 is performed for each workpiece.

As described above, in printing in which a plurality of print operations are performed on the first workpiece W1 in sequence, the second print operation S20 is executed last among the plurality of print operations. Therefore, the second substitute image Gb2 can be acquired or created by combination during the execution of the print operation executed before the second print operation S20.

As described above, when n first images, n being a natural number more than or equal to 1, each of which is a single image, and m second images, m being a natural number more than or equal to 1, each of which is a combined image, are printed on the first workpiece W1 or second workpiece W2, n print operations to print the n first images are all executed before m print operations to print the m second images are executed. Therefore, since print operations for combined images are performed after all print operations for single images have been performed, a long time is available to prepare combined images.

### 2. Variations

Many variations are possible for the embodiment exemplified above. Aspects of specific variations that can be applied to the embodiment described above will be exemplified below. Any two or more aspects selected from the exemplary examples described below can be appropriately combined within a range in which any mutual contradiction does not occur.

### 2-1. Variation 1

In the embodiment described above, a case in which the first substitute image Gb1 and second substitute image Gb2 are each a combined image has been exemplified. However, this is not a limitation. For example, the first substitute image Gb1 and second substitute image Gb2 may be each an image created only from the substitute data D3 without using third image data D2b.

### 2-2. Variation 2

In the embodiment described above, a structure has been exemplified in which a six-axis vertical articulated robot is used as the robot 2. However, the present disclosure is not limited to this structure. For example, the robot 2 may be a vertical articulated robot other than six-axis vertical articulated robots or may be a horizontal articulated robot. The arm section 220 of the robot 2 may have an expansion and contraction mechanism, a linear motion mechanism, and the like, besides articulations 230, each of which is formed by using a swing mechanism. However, from the viewpoint of a balance between print quality in print operation and degrees of freedom in the operation of the robot 2 in non-print operation, the robot 2 is preferably an articulated robot having six or more axes.

### 2-3. Variation 3

In the embodiment described above, a structure has been exemplified in which screwing or the like is used as a method of fixing the head 3a to the robot 2. However, the present disclosure is not limited to this structure. For example, the head 3a may be fixed to the robot 2 by using a holding mechanism, such as a hand, that is attached as an end effector of the robot 2 to hold the head 3a.

### 2-4. Variation 4

In the embodiment described above, the robot 2 structured so that the head 3a is moved has been exemplified. However, the present disclosure is not limited to this structure. For example, a liquid discharge head may be fixed at a stationary position and the robot 2 may move the workpiece W so that the position and orientation of the workpiece W is three-dimensionally changed with respect to the liquid discharge head. In this case, the workpiece W is held by, for example, a holding mechanism, such as a hand, that is attached to the top end of the robot arm 220.

### 2-5. Variation 5

In the embodiment described above, a structure has been exemplified in which one type of ink is used in printing. However, the present disclosure is not limited to this structure. The present disclosure can also be applied to a structure in which two or more types of ink are used in printing.

### 2-6. Variation 6

Applications of the three-dimensional object printing apparatus 1 in the present disclosure are not limited to printing. For example, the three-dimensional object printing apparatus 1 that discharges a color material solution is used as a manufacturing apparatus that forms color filters for liquid crystal display devices. In another example, the three-dimensional object printing apparatus 1 that discharges a conductive material solution is used as a manufacturing apparatus that forms wiring and electrodes on wiring boards. In yet another example, the three-dimensional object printing apparatus 1 can also be used as a jet dispenser that applies an adhesive or another liquid to a medium.

What is claimed is:

1. A three-dimensional object printing apparatus that executes printing of a first common image and a first substitute image on a first workpiece, which is three-dimensional, and also executes printing of a second common image and a second substitute image on a second workpiece, which is also three-dimensional, wherein:
the first common image and the second common image are the same image;
the first substitute image and the second substitute image are at least partially different from each other; and
the three-dimensional object printing apparatus executes a first print operation, in which the first common image is printed on the first workpiece, before executing a second print operation, in which the first substitute image is printed on the first workpiece.

2. The three-dimensional object printing apparatus according to claim 1, wherein the three-dimensional object printing apparatus executes a third print operation, in which the second common image is printed on the second workpiece, before executing a fourth print operation, in which the second substitute image is printed on the second workpiece.

3. The three-dimensional object printing apparatus according to claim 2, wherein the three-dimensional object printing apparatus executes the first print operation, followed by the second print operation, followed by the third print operation, followed by the fourth print operation.

4. The three-dimensional object printing apparatus according to claim 1, comprising a processing section used to process image data; wherein during execution of a print operation for the first workpiece, the processing section executes processing for creating or acquiring image data, which is for use for the second substitute image.

5. The three-dimensional object printing apparatus according to claim 4, wherein during execution of the second print operation, the processing section executes processing for creating or acquiring image data, which is for use for the second substitute image.

6. The three-dimensional object printing apparatus according to claim 1, wherein:
the first workpiece has a first surface and a second surface oriented in a different direction from the first surface;
the first common image is printed on the first surface; and
the first substitute image is printed on the second surface.

7. The three-dimensional object printing apparatus according to claim 1, comprising a processing section used to process image data; wherein
the processing section creates first print data by processing first image data; and
both the first common image and the second common image are printed by using the first print data.

8. The three-dimensional object printing apparatus according to claim 1, wherein printing is performed by performing a plurality of print operations on the first workpiece in sequence; and
the second print operation is executed last among the plurality of print operations.

9. A three-dimensional object printing apparatus that prints, on a three-dimensional workpiece, a single image created from one piece of image data and a combined image created from a plurality of pieces of image data, wherein the three-dimensional object printing apparatus executes a first print operation, in which the single image is printed, before executing a second print operation, in which the combined image is printed.

10. The three-dimensional object printing apparatus according to claim 9, wherein:
the workpiece has a first surface and a second surface oriented in a different direction from the first surface;
the single image is printed on the first surface; and
the combined image is printed on the second surface.

11. The three-dimensional object printing apparatus according to claim 9, comprising a processing section used to process image data; wherein during execution of the first print operation, the processing section performs processing for creating data that indicates the combined image by combining a plurality of pieces of image data.

12. The three-dimensional object printing apparatus according to claim 9, further comprising an acquiring section used to acquire image data, wherein during execution of the first print operation, the acquiring section acquires data related to the combined image.

13. The three-dimensional object printing apparatus according to claim 9, wherein when n first images, n being a natural number more than or equal to 1, each of which is a single image, and m second images, m being a natural number more than or equal to 1, each of which is a combined image, are printed on the workpiece, n print operations to print the n first images are all executed before m print operations to print the m second images are executed.

14. A three-dimensional object printing method of executing printing of a first common image and a first substitute image on a first workpiece, which is three-dimensional, and also executing printing of a second common image and a second substitute image on a second workpiece, which is also three-dimensional, wherein:
the first common image and the second common image are the same image;
the first substitute image and the second substitute image are at least partially different from each other; and
a first print operation, in which the first common image is printed on the first workpiece, is executed before a second print operation, in which the first substitute image is printed on the first workpiece, is executed.
